(19) United States
(12) Patent Application Publication
(10) Pub. No.: US 2022/0100068 A1
(43) Pub. Date: Mar. 31, 2022

(54) WAVELENGTH CONVERSION MEMBER AND PROJECTOR

(71) Applicant: Panasonic Intellectual Property Management Co., Ltd., Osaka (JP)

(72) Inventors: Yoshihisa NAGASAKI, Osaka (JP); Takashi OHBAYASHI, Osaka (JP); Naoyuki TANI, Osaka (JP); Nobuyasu SUZUKI, Osaka (JP); Takahiro HAMADA, Osaka (JP); Yukihiko SUGIO, Osaka (JP)

(73) Assignee: Panasonic Intellectual Property Management Co., Ltd., Osaka (JP)

(21) Appl. No.: 17/426,329

(22) PCT Filed: Oct. 17, 2019
(86) PCT No.: PCT/JP2019/040803

§ 371 Date: Jul. 28, 2021

(30) Foreign Application Priority Data
Feb. 4, 2019 (JP) 2019-018205

(51) Int. Cl. G03B 21/20; G03B 21/16; C09K 11/02; C09K 11/77; C09K 5/14

(52) U.S. Cl. CPC G03B 21/204; G03B 21/16; C09K 5/14; C09K 11/7774; C09K 11/02

(57) ABSTRACT

Provided is a technique for suppressing a temperature rise of a wavelength conversion member. The present disclosure is provided with: phosphor layer containing a phosphor; substrate that supports phosphor layer; and heat sink bonded to substrate, wherein the thermal conductivity of substrate is greater than the thermal conductivity of phosphor layer, and the thermal conductivity of heat sink is greater than the thermal conductivity of substrate, or the thermal conductivity of heat sink is smaller than the thermal conductivity of substrate.

### TECHNICAL FIELD

The present disclosure relates to a wavelength conversion member and a projector.

### BACKGROUND ART

In recent years, a light source including a light emitting element and a wavelength conversion member has been developed. The wavelength conversion member has phosphor particles embedded in a matrix. Light from the light emitting element is radiated to the phosphor particles as excitation light, and light having a wavelength longer than the wavelength of the excitation light is emitted from a phosphor.

It is known that, when the temperature of the wavelength conversion member rises too high, the brightness of light is significantly reduced due to temperature quenching of the phosphor. In order to increase the brightness of light and the output of light, it is important to suppress the temperature rise of the wavelength conversion member.

PTL 1 discloses a light source device including a solid light source, a phosphor layer, and a heat dissipation substrate. The phosphor layer is bonded to the heat dissipation substrate via metal.

### CITATION LIST

### Patent Literature

PTL 1: Unexamined Japanese Patent Publication No. 2011-129354
PTL 2: WO 2013/172025 A

### SUMMARY OF THE INVENTION

The present disclosure provides a technique for suppressing a temperature rise of a wavelength conversion member.

The wavelength conversion member according to the present disclosure includes a phosphor layer containing a phosphor, a substrate that supports the phosphor layer, and a heat sink bonded to the substrate. In the wavelength conversion member, the thermal conductivity of the substrate is greater than the thermal conductivity of the phosphor layer, and the thermal conductivity of the heat sink and the thermal conductivity of the substrate are different from each other.

According to the present disclosure, it is possible to suppress a temperature rise of the wavelength conversion member.

In the wavelength conversion member according to the present disclosure, it is further preferable that the thermal conductivity of the heat sink is greater than the thermal conductivity of the substrate.

In the wavelength conversion member according to the present disclosure, it is further preferable that the thermal conductivity of the heat sink is greater than the thermal conductivity of the substrate.

### BRIEF DESCRIPTION OF DRAWINGS

FIG. 1A is a schematic cross-sectional view of a wavelength conversion member according to an exemplary embodiment of the present disclosure.

FIG. 1B is a schematic cross-sectional view of a phosphor layer.

FIG. 2 is a schematic cross-sectional view of a light source using the wavelength conversion member according to the present disclosure.

FIG. 3 is a diagram schematically showing a configuration of a projector using the wavelength conversion member according to the present disclosure.

FIG. 4 is a diagram schematically showing a configuration of a lighting device using the light source according to the present disclosure.

FIG. 5 is a graph showing a relationship between an output of incident laser beam and an intensity of emitted fluorescent light.

FIG. 6 is a graph showing a change in the surface temperature of the phosphor layer with respect to the thickness of the substrate.

FIG. 7 is another graph showing a change in the surface temperature of the phosphor layer with respect to the thickness of the substrate.

### DESCRIPTION OF EMBODIMENT

### (Findings Which are a Basis of the Present Disclosure)

The temperature rise of a wavelength conversion member becomes more significant as an output of excitation light increases. For example, a high-power blue semiconductor laser is used in a laser projector that has become widespread in recent years. A light source of the laser projector can be constructed by combining a blue semiconductor laser and a wavelength conversion member capable of emitting yellow light. The wavelength conversion member usually includes a rotary wheel substrate and an annular phosphor layer provided on the rotary wheel substrate. The rotary wheel substrate can prevent a laser beam from being concentrated at a specific position on the phosphor layer. As a result, a temperature rise of the phosphor layer is suppressed.

The advantages of the laser projector are its small size, light weight, and long life of the light source. If the rotary wheel substrate can be eliminated, a driving device such as a motor can be eliminated, so that further miniaturization, weight reduction, and cost reduction of the laser projector can be expected. If the driving device can be eliminated, it is possible to provide a highly reliable laser projector that is resistant to external vibration and that does not cause problems due to wear of a rotating shaft.

However, if the rotary wheel substrate is eliminated, a problem of temperature rise of the phosphor layer comes to the surface. It is conceivable to use a fixed heat sink instead of the rotary wheel substrate in order to suppress the temperature rise of the wavelength conversion member. However, a cooling effect of the fixed heat sink is not always sufficient. Therefore, it is necessary to more carefully study a configuration that can prevent an excessive temperature rise of the phosphor layer and prevent the phosphor layer from being peeled from the substrate due to a hot-cold cycle.

### (Summary of One Aspect According to the Present Disclosure)

The wavelength conversion member according to a first aspect of the present disclosure includes a phosphor layer containing a phosphor, a substrate that supports the phosphor layer, and a heat sink bonded to the substrate. A thermal conductivity of the substrate is greater than a thermal conductivity of the phosphor layer, and a thermal conductivity of the heat sink and the thermal conductivity of the substrate are different from each other.

According to the above configuration, sufficient heat dissipation from the phosphor layer to the heat sink can be ensured, and a change in thermal conductivity at the joint portion between the phosphor layer and the heat sink can be reduced. This makes it possible to prevent damage to the wavelength conversion member due to a difference in thermal expansion.

According to a second aspect of the present disclosure, in the wavelength conversion member according to the first aspect, for example, the thermal conductivity of the heat sink may be greater than the thermal conductivity of the substrate. According to the second aspect, the above effect can be sufficiently obtained.

According to a third aspect of the present disclosure, in the wavelength conversion member according to the second aspect, for example, it is preferable that the substrate has a thickness ranging from 100 μm to 1000 μm inclusive. According to the third aspect, it is possible to prevent the wavelength conversion member from being damaged by heat.

According to a fourth aspect of the present disclosure, for example, the wavelength conversion member according to the second or third aspect may further include a first adhesive layer provided between the phosphor layer and the substrate, and it is preferable that the thickness of the first adhesive layer is 1/1000 or more and 1/10 or less of the thickness of the phosphor layer, and that the thermal conductivity of the first adhesive layer is smaller than the thermal conductivity of the phosphor layer. According to the fourth aspect, damage to the wavelength conversion member due to a difference in thermal expansion can be prevented.

According to a fifth aspect of the present disclosure, for example, the wavelength conversion member according to any one of the second to fourth aspects may further include a second adhesive layer provided between the substrate and the heat sink, and it is preferable that the thickness of the second adhesive layer is 1/1000 or more and 1/10 or less of the thickness of the substrate, and that the thermal conductivity of the second adhesive layer is smaller than the thermal conductivity of the substrate. According to the fifth aspect, damage to the wavelength conversion member due to a difference in thermal expansion can be prevented.

According to a sixth aspect of the present disclosure, in the wavelength conversion member according to any one of the second to fifth aspects, for example, the substrate may be including silicon. When the substrate is made of silicon, the abovementioned thermal conductivity relationship can be easily satisfied.

According to a seventh aspect of the present disclosure, in the wavelength conversion member according to the first aspect, for example, the thermal conductivity of the heat sink may be smaller than the thermal conductivity of the substrate. According to the seventh aspect, the effect described in the first aspect can be sufficiently obtained.

According to an eighth aspect of the present disclosure, in the wavelength conversion member according to the seventh aspect, for example, it is preferable that the substrate has a thickness equal to or greater than 100 μm. According to the eighth aspect, it is possible to prevent the wavelength conversion member from being damaged by heat.

According to a ninth aspect of the present disclosure, for example, the wavelength conversion member according to the seventh or eighth aspect may further include a first adhesive layer provided between the phosphor layer and the substrate, and it is preferable that the thickness of the first adhesive layer is 1/500 or more and 3/20 or less of the thickness of the phosphor layer, and that the thermal conductivity of the first adhesive layer is smaller than the thermal conductivity of the phosphor layer. According to the ninth aspect, damage to the wavelength conversion member due to a difference in thermal expansion can be prevented.

According to a tenth aspect of the present disclosure, for example, the wavelength conversion member according to any one of the seventh to ninth aspects may further include a second adhesive layer provided between the substrate and the heat sink, and it is preferable that the thickness of the second adhesive layer is 1/1000 or more and ½ or less of the thickness of the substrate, and that the thermal conductivity of the second adhesive layer is smaller than the thermal conductivity of the substrate. According to the tenth aspect, damage to the wavelength conversion member due to a difference in thermal expansion can be prevented.

According to an eleventh aspect of the present disclosure, in the wavelength conversion member according to any one of the seventh to tenth aspects, for example, it is preferable that the substrate is including silicon carbide (SiC). When the substrate is made of SiC, the abovementioned thermal conductivity relationship can be easily satisfied.

According to a twelfth aspect of the present disclosure, in the wavelength conversion member according to any one of the first to tenth aspects, for example, it is preferable that the phosphor layer is including an inorganic material. According to the twelfth aspect, heat resistance of the wavelength conversion member can be sufficiently ensured.

According to a thirteenth aspect of the present disclosure, in the wavelength conversion member according to any one of the first to the twelfth aspects, for example, the phosphor layer may have a plurality of phosphor particles and a zinc oxide matrix in which the plurality of phosphor particles are embedded. According to the thirteenth aspect, heat of the phosphor layer is easily released to the outside (mainly to the substrate).

A projector according to the fourteenth aspect of the present disclosure includes a light emitting element and the wavelength conversion member according to any one of the first to thirteenth aspects that is located on an optical path of light emitted from the light emitting element.

According to the fourteenth aspect, it is possible to provide a projector that does not have a driving unit such as a motor.

Exemplary embodiments of the present disclosure will be described below with reference to the drawings. The present disclosure is not limited to the following exemplary embodiments.

### Exemplary Embodiment of Wavelength Conversion Member

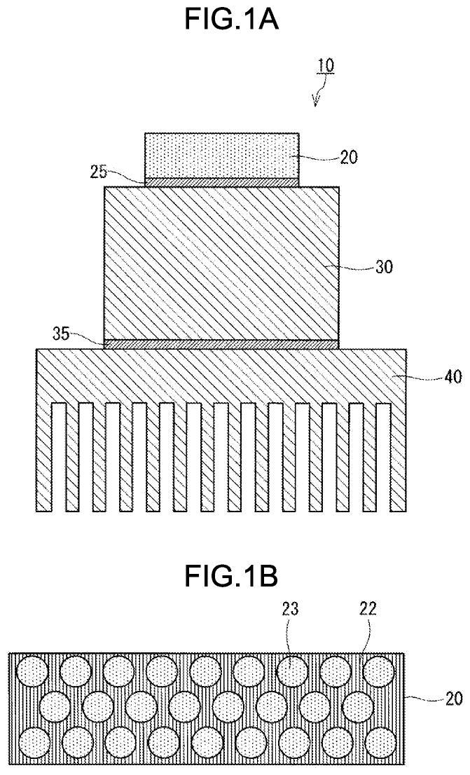

FIG. 1A shows a cross section of wavelength conversion member 10 according to one exemplary embodiment of the present disclosure. FIG. 1B shows an enlarged cross section of phosphor layer 20. Wavelength conversion member 10 includes phosphor layer 20, substrate 30, and heat sink 40. Phosphor layer 20, substrate 30, and heat sink 40 are laminated in this order. Phosphor layer 20 contains a phosphor. Substrate 30 supports phosphor layer 20. Heat sink 40 is bonded to substrate 30. Specifically, heat sink 40 is bonded to the back surface of substrate 30.

When being irradiated with excitation light having a first wavelength band, wavelength conversion member 10 converts a portion of the excitation light into light having a second wavelength band and emits the resultant light. Wavelength conversion member 10 emits light having a wavelength longer than the wavelength of the excitation light. The second wavelength band is different from the first wavelength band. However, a part of the second wavelength band may overlap with the first wavelength band. Light emitted from wavelength conversion member 10 may include not only light emitted from the phosphor but also the excitation light itself.

In the present exemplary embodiment, the thermal conductivity of substrate 30 is greater than the thermal conductivity of phosphor layer 20. The thermal conductivity of heat sink 40 is greater than the thermal conductivity of substrate 30. When the thermal conductivity of phosphor layer 20 is represented by κ1, the thermal conductivity of substrate 30 is represented by κ2, and the thermal conductivity of heat sink 40 is represented by κ3, wavelength conversion member 10 satisfies the relationship of κ3>κ2>κ1. The unit of thermal conductivity is (W/m·K). With this configuration, it is possible to sufficiently ensure heat dissipation from phosphor layer 20 to heat sink 40 and to reduce a change in thermal conductivity at the joint portion between phosphor layer 20 and heat sink 40. Thus, damage to wavelength conversion member 10 due to a difference in thermal expansion can be prevented.

The thickness of substrate 30 is, for example, from 100 μm to 1000 μm inclusive. When the thickness of substrate 30 is adjusted appropriately while satisfying the thermal conductivity relationship of κ3>κ2>κ1, it is possible to suppress a difference in thermal expansion between phosphor layer 20 and substrate 30 and a difference in thermal expansion between substrate 30 and heat sink 40, while maintaining excellent heat dissipation performance of wavelength conversion member 10. Thus, damage of wavelength conversion member 10 due to heat can be prevented.

The thickness of substrate 30 is typically greater than the thickness of phosphor layer 20. When the thickness of phosphor layer 20 is represented by T1 (μm) and the thickness of substrate 30 is represented by T2 (μm), the ratio between thickness T1 and thickness T2 (T2/T1) is, for example, greater than 1 and not more than 33. The ratio (T2/T1) is preferably from 2 to 17 inclusive. However, the thickness of substrate 30 may be less than the thickness of phosphor layer 20.

Substrate 30 has a function of transmitting heat of phosphor layer 20 to heat sink 40 in addition to supporting phosphor layer 20. The material of substrate 30 is not particularly limited as long as the abovementioned thermal conductivity relationship is satisfied. Substrate 30 is made of, for example, sapphire (Al₂O₃), gallium nitride (GaN), aluminum nitride (AlN), silicon (Si), aluminum (Al), an aluminum alloy, copper (Cu), a copper alloy, glass, quartz (SiO₂), silicon carbide (SiC), or zinc oxide (ZnO). Substrate 30 may have a mirror-polished surface.

In one example, substrate 30 is a silicon substrate. In a case where substrate 30 is made of silicon, the thermal conductivity relationship of κ3>κ2>κ1 can be easily satisfied.

Silicon may be silicon single crystal or polycrystalline silicon. The thermal conductivity of silicon single crystal is higher than that of polycrystalline silicon. From the viewpoint of excellent heat conduction from phosphor layer 20 to heat sink 40, it is preferable that substrate 30 is made of a silicon single crystal. In other words, substrate 30 can be a silicon single crystal substrate. The silicon single crystal substrate can be produced by a method of crystal growth such as the Czochralski method or floating-zone process. In addition, the thermal expansion coefficient of a silicon single crystal is small. If a silicon single crystal is used, it is easy to obtain a high-quality smooth surface. When the material of substrate 30 is a silicon single crystal, substrate 30 has both high thermal conductivity and high smoothness. Therefore, a difference in temperature between phosphor layer 20 and substrate 30 and a difference in temperature between substrate 30 and heat sink 40 are less likely to increase, and further, starting points of breakage and peeling are reduced. As a result, it is possible to prevent phosphor layer 20 from peeling from substrate 30, and it is also possible to prevent phosphor layer 20 and substrate 30 from being damaged.

The surface of substrate 30 may have an antireflective film, a dichroic mirror, a metal reflective film, a high reflective film, a protective film, and the like. In other words, the surface layer portion of substrate 30 may be composed of these functional films. The antireflective film is a film for preventing reflection of excitation light. The dichroic mirror may include a dielectric multilayer film. The metal reflective film is a film for reflecting light and is made of a metal material such as silver or aluminum. The high reflective film may include a dielectric multilayer film. The protective film can be a film for physically or chemically protecting these films.

Thin films such as dielectric multilayer films are very thin. Therefore, the thermal conductivity of the constituent materials of the bulk portion excluding the thin films can be regarded as the thermal conductivity of substrate 30.

In the example shown in FIG. 1A, both phosphor layer 20 and substrate 30 have a plate shape. The area of an upper surface of substrate 30 is larger than the area of a lower surface of phosphor layer 20. The outer edge of phosphor layer 20 is located inside the outer edge of substrate 30 in a plan view of wavelength conversion member 10. However, the area of the upper surface of substrate 30 may be equal to the area of the lower surface of phosphor layer 20. In other words, the outer edge of the upper surface of substrate 30 may be aligned with the outer edge of the lower surface of phosphor layer 20 in a plan view of wavelength conversion member 10. The “area of the upper surface” and the “area of the lower surface” are the areas in a plan view of wavelength conversion member 10, respectively.

Similarly, the area of an upper surface of heat sink 40 is larger than the area of a lower surface of substrate 30. The outer edge of substrate 30 is located inside the outer edge of heat sink 40 in a plan view of wavelength conversion member 10. However, the area of the upper surface of heat sink 40 may be equal to the area of the lower surface of substrate 30. In other words, the outer edge of the upper surface of heat sink 40 may be aligned with the outer edge of the lower surface of substrate 30 in a plan view of wavelength conversion member 10.

As shown in FIG. 1B, phosphor layer 20 has matrix 22 and phosphor particles 23. Matrix 22 exists between the particles. Each particle is embedded in matrix 22. In other words, the particles are dispersed in matrix 22.

The material of phosphor particles 23 is not particularly limited. Various phosphors can be used as materials for phosphor particles 23. Specifically, phosphors such as Y₃Al₅O₁₂:Ce(YAG), (Y, Gd)₃Al₅O₁₂:Ce(YGAG), Y₃(Al, Ga)₅O₁₂:Ce(YAGG), (Y, Gd)₃(Al, Ga)₅O₁₂:Ce (GYAGG), Lu₃Al₅O₁₂:Ce(LuAG), (Si, Al)₆(O, N)₈:Eu(β-SiAlON), (La, Y)₃Si₆N₁₁:Ce(LYSN), or Lu₂CaMg₂Si₃O₁₂:Ce (LCMS) can be used. Phosphor particles 23 may contain a plurality of types of phosphor particles having different compositions. The wavelength of excitation light to be applied to phosphor particles 23 and the wavelength of light (fluorescent light) to be emitted from phosphor particles 23 are selected according to intended use of wavelength conversion member 10. For example, when wavelength conversion member 10 is used as a light source of a laser projector, the phosphor can be a yellow phosphor such as Y₃Al₅O₁₂:Ce.

The average particle size of phosphor particles 23 ranges from 0.1 μm to 50 μm inclusive, for example. The average particle size of phosphor particles 23 can be specified by, for example, the following method. First, the cross section of wavelength conversion member 10 is observed with a scanning electron microscope. In the obtained electron microscopic image, the area of specific phosphor particle 23 is calculated by image processing. The diameter of a circle having the same area as the calculated area is regarded as the particle size (particle diameter) of specific phosphor particle 23. The particle sizes of an arbitrary number (for example, 50) of phosphor particles 23 are calculated, and the average value of the calculated values is regarded as the average particle size of phosphor particles 23. In the present disclosure, the shape of phosphor particle 23 is not limited. The shape of phosphor particle 23 may be spherical, flaky, or fibrous. In the present disclosure, the method for measuring the average particle size is not limited to the above method.

Matrix 22 is made of, for example, resin, glass, or other inorganic materials. Examples of resin include silicone resin and acrylic resin. Examples of other inorganic materials include Al₂O₃, ZnO, and SiO₂. The other inorganic materials may be crystalline. It is desirable that matrix 22 has translucency with respect to the excitation light and light emitted from phosphor particles 23. Matrix 22 may have a refractive index higher than that of phosphor particles 23, or may have a refractive index lower than that of phosphor particles 23.

When phosphor layer 20 is made of an inorganic material, in other words, when matrix 22 is made of an inorganic material, the heat resistance of wavelength conversion member 10 can be sufficiently ensured.

From the viewpoint of transparency and thermal conductivity, ZnO is suitable as the material of matrix 22. ZnO has high thermal conductivity. Therefore, when matrix 22 is made of ZnO, heat of phosphor layer 20 is easily released to the outside (mainly to substrate 30). This contributes to the excellent heat dissipation performance of wavelength conversion member 10.

ZnO as the material of matrix 22 is specifically a ZnO single crystal or a c-axis oriented ZnO polycrystal. ZnO has a wurtzite-type crystal structure. The “c-axis oriented ZnO” means that the plane parallel to the main surface of substrate 30 is the c-plane. The “main surface” means the surface having the largest area.

The c-axis oriented ZnO polycrystal contains a plurality of columnar crystal grains oriented along the c-axis. In the c-axis oriented ZnO polycrystal, the grain boundaries in the c-axis direction are small. The wording “columnar crystal grains are oriented along the c-axis” means that the growth of ZnO in the c-axis direction is faster than the growth of ZnO in the a-axis direction, and vertically long ZnO crystal grains are formed on substrate 30. The c-axis of the ZnO crystal grains is parallel to the normal direction of substrate 30. Alternatively, the inclination of the c-axis of the ZnO crystal grains with respect to the normal direction of substrate 30 is 4° or less. Here, the wording “the inclination of the c-axis is 4° or less” means that the distribution of the inclination of the c-axis is 4° or less, and does not always mean that the inclination of the c-axis of all crystal grains is 4° or less. The “inclination of the c-axis” can be evaluated by the full width at half maximum by the X-ray diffraction rocking curve method for assessment of c-axis orientation. Specifically, the full width at half maximum of the c-axis by the X-ray diffraction rocking curve method is 4° or less. PTL 2 discloses in detail a matrix composed of c-axis oriented ZnO polycrystals.

Phosphor layer 20 may contain filler particles dispersed in matrix 22. The material of the filler particles may be an organic material, an inorganic material, or an organic-inorganic hybrid material. Examples of the organic material include acrylic resin. Examples of the inorganic material include metal oxides. Examples of the organic-inorganic hybrid material include silicone resin.

In one example, the filler particles include at least one selected from SiO₂ particles, Al₂O₃, and TiO₂ particles. These particles are chemically stable and inexpensive. The shape of the filler particles is also not limited. The shape of the filler particles may be spherical, flaky, or fibrous.

Phosphor layer 20 may be made of a ceramic phosphor or may be made of a single crystal of a phosphor. In these cases, phosphor layer 20 has no matrix.

Heat sink 40 is bonded to the back surface of substrate 30 and has a function of taking heat from phosphor layer 20 through substrate 30 and releasing the heat to a cooling source such as ambient air. Heat sink 40 is typically made of a metal material such as aluminum, an aluminum alloy, copper, a copper alloy, or stainless steel. Heat sink 40 has a flat upper surface that supports substrate 30. Heat sink 40 may have a plurality of heat dissipation fins extending from the back surface.

Wavelength conversion member 10 further includes first adhesive layer 25 provided between phosphor layer 20 and substrate 30. First adhesive layer 25 is in contact with both phosphor layer 20 and substrate 30. The thickness of first adhesive layer 25 can be 1/1000 or more and 1/10 or less of the thickness of phosphor layer 20. The thickness of first adhesive layer 25 is sufficiently smaller than the thickness of phosphor layer 20. The thermal conductivity of first adhesive layer 25 is smaller than the thermal conductivity of phosphor layer 20, for example. When the thermal conductivity of phosphor layer 20 is represented by κ1, and the thermal conductivity of first adhesive layer 25 is represented by κ4, wavelength conversion member 10 satisfies the relationship of κ1>κ4. By providing first adhesive layer 25, it is possible to suppress rapid heat conduction from phosphor layer 20 to substrate 30 while maintaining excellent heat dissipation performance of wavelength conversion member 10. Thus, damage to wavelength conversion member 10 due to a difference in thermal expansion can be prevented.

First adhesive layer 25 has a function of strengthening the bonding between phosphor layer 20 and substrate 30. The material of first adhesive layer 25 is not particularly limited as long as the above relationship is satisfied. The material of first adhesive layer 25 may be an organic material, an inorganic material, or a mixture of an organic material and an inorganic material. Examples of the organic material include silicone-based adhesives, epoxy-based adhesives, acrylic-based adhesives, and cyanoacrylate-based adhesives. Examples of the inorganic material include SiO₂, Al₂O₃, TiO₂, Nb₂O₅, Ta₂O₅, MgO, ZnO, B₂O₃, Y₂O₃, SiC, diamond, Ag, Cu, and Au. Examples of the mixture of the organic material and the inorganic material include a heat release grease and a heat release adhesive. The heat release grease is, for example, a mixture of resin and filler particles. The resin is, for example, a silicone resin. The filler particles can be metal or metal oxide particles. The heat release adhesive can also be a mixture of resin and filler particles. The resin used for the heat release grease exhibits tackiness, whereas the resin used for the heat release adhesive exhibits adhesiveness.

Wavelength conversion member 10 further includes second adhesive layer 35 provided between substrate 30 and heat sink 40. Second adhesive layer 35 is in contact with both substrate 30 and heat sink 40. The thickness of second adhesive layer 35 can be 1/1000 or more and 1/10 or less of the thickness of substrate 30. The thickness of second adhesive layer 35 is sufficiently smaller than the thickness of substrate 30. The thermal conductivity of second adhesive layer 35 is smaller than the thermal conductivity of substrate 30, for example. When the thermal conductivity of substrate 30 is represented by κ2, and the thermal conductivity of second adhesive layer 35 is represented by κ5, wavelength conversion member 10 satisfies the relationship of κ2>κ5. By providing second adhesive layer 35, it is possible to suppress rapid heat conduction from substrate 30 to heat sink 40 while maintaining excellent heat dissipation performance of wavelength conversion member 10. Thus, damage to wavelength conversion member 10 due to a difference in thermal expansion can be prevented.

Second adhesive layer 35 has a function of strengthening the bonding between substrate 30 and heat sink 40. The material of second adhesive layer 35 is not particularly limited as long as the above relationship is satisfied. The material of second adhesive layer 35 may be an organic material, an inorganic material, or a mixture of an organic material and an inorganic material. Examples of the organic material include silicone-based adhesives, epoxy-based adhesives, acrylic-based adhesives, and cyanoacrylate-based adhesives. Examples of the inorganic material include SiO₂, Al₂O₃, TiO₂, Nb₂O₅, Ta₂O₅, MgO, ZnO, B₂O₃, Y₂O₃, SiC, diamond, Ag, Cu, Au, glass, an Au—Sn alloy, a In—Ga alloy, Sn solder, and Pb solder. Examples of the mixture of the organic material and the inorganic material include a heat release grease and a heat release adhesive. The heat release grease is, for example, a mixture of resin and filler particles. The resin is, for example, a silicone resin. The filler particles can be metal or metal oxide particles.

As used herein, thermal conductivity means thermal conductivity at 0° C. The thermal conductivities of phosphor layer 20, first adhesive layer 25, substrate 30, second adhesive layer 35, and heat sink 40 can be the thermal conductivities of the materials constituting them. For example, when substrate 30 is made of a silicon single crystal, the thermal conductivity of the silicon single crystal at 0° C. is regarded as the thermal conductivity of substrate 30.

The thermal conductivity of a mixture containing a plurality of materials such as phosphor layer 20 can be calculated by the following Bruggeman formula.

$$1 \cdot Φ = [ ( λ c - λ f ) / ( λ m - λ f ) ] \times {( λ m / λ c )}^{1 / 3}$$

Φ: Volume filling factor of fillers (phosphor particles, inorganic particles, etc.)

λc: Thermal conductivity of the mixture (phosphor layer or adhesive layer)

λf: Thermal conductivity of fillers (phosphor particles, inorganic particles, etc.)

λm: Thermal conductivity of the matrix

In the present specification, the thicknesses of phosphor layer 20, first adhesive layer 25, substrate 30, and second adhesive layer 35 can be measured by the following methods. Wavelength conversion member 10 is cut in the thickness direction, and the cross section is observed with an optical microscope or an electron microscope. The thicknesses at any plurality of points (for example, 5 points) are measured by image processing. The average value of the measured values can be regarded as the thickness.

Next, a method of manufacturing wavelength conversion member 10 will be described.

First, substrate 30 is prepared. Substrate 30 is obtained by cutting a raw substrate such as a silicon single crystal wafer into a predetermined size. If necessary, a functional film such as a metal reflective film or a dielectric multilayer film may be formed on the raw substrate.

Next, first adhesive layer 25 is formed on substrate 30. In a case where first adhesive layer 25 is made of an organic material such as a heat release grease, first adhesive layer 25 can be formed by applying an organic material onto substrate 30. In a case where first adhesive layer 25 is made of an inorganic material such as SiO₂, first adhesive layer 25 can be formed by depositing an inorganic material such as SiO₂ on substrate 30 by a deposition method such as a sputtering method, a vapor deposition method, or a (chemical vapor deposition) CVD method. First adhesive layer 25 may be formed by applying a solution containing the raw material of first adhesive layer 25 to substrate 30. Liquid glass is an example of such a solution.

First adhesive layer 25 may not be provided.

Next, phosphor layer 20 is formed. In a case where matrix 22 is made of a resin, phosphor particles 23 are mixed with a solution containing the resin and a solvent to prepare a coating liquid. The coating liquid is applied to substrate 30 or first adhesive layer 25 such that a coating film is formed on substrate 30 or first adhesive layer 25. The coating film is dried or cured, whereby phosphor layer 20 is formed.

In a case where matrix 22 is made of ZnO, matrix 22 can be formed by, for example, a sol-gel method. First, a sol mixture containing a precursor such as zinc alkoxide and phosphor particles 23 is prepared. The sol mixture is applied to substrate 30 or first adhesive layer 25 such that a coating film is formed on substrate 30 or first adhesive layer 25. The coating film is turned into a gel and baked, whereby wavelength conversion member 10 is obtained.

In a case where matrix 22 is a ZnO single crystal or a c-axis oriented ZnO polycrystal, matrix 22 can be formed on substrate 30 or first adhesive layer 25 by a solution-growth method. First, a crystalline ZnO thin film as a seed layer is formed on substrate 30 or first adhesive layer 25. As a method for forming the ZnO thin film, a vacuum film formation method such as an electron beam vapor deposition method, a reactive plasma vapor deposition method, a sputtering method, or a pulsed laser deposition method is used. Next, a layer containing phosphor particles 23 is formed on substrate 30 or first adhesive layer 25. For example, a dispersion liquid containing phosphor particles 23 is prepared. Substrate 30 is placed in the dispersion liquid, and phosphor particles 23 are deposited on substrate 30 or first adhesive layer 25 using electrophoresis. Thus, the layer containing phosphor particles 23 can be formed on substrate 30 or first adhesive layer 25. The layer containing phosphor particles 23 can also be formed on substrate 30 or first adhesive layer 25 by placing substrate 30 in the dispersion liquid and precipitating phosphor particles 23. It is also possible to form the layer containing phosphor particles 23 on substrate 30 or first adhesive layer 25 by a thin film formation method such as a printing method using a coating liquid containing phosphor particles 23.

Next, matrix 22 is formed between the particles by a solution-growth method using a solution containing Zn. As the solution-growth method, a chemical bath deposition method performed under atmospheric pressure, a hydrothermal synthesis method performed under atmospheric pressure or higher, an electrochemical deposition method in which a voltage or current is applied, etc. are used. As the solution for crystal growth, an aqueous solution of zinc nitrate containing hexamethylenetetramine is used, for example. Crystalline matrix 22 epitaxially grows on the crystalline ZnO thin film as a seed layer.

Note that, in a case where phosphor layer 20 is a phosphor ceramic or a single crystal of a phosphor, the heat release grease or the heat release adhesive as first adhesive layer 25 is applied to the phosphor ceramic or the single crystal of the phosphor, and the phosphor ceramic or the single crystal of the phosphor is bonded to substrate 30.

Next, second adhesive layer 35 is formed on at least one of the back surface of substrate 30 and the upper surface of heat sink 40. In a case where second adhesive layer 35 is made of a heat release grease or a heat release adhesive, second adhesive layer 35 can be formed by applying these materials to at least one of the back surface of substrate 30 and the upper surface of heat sink 40.

Then, heat sink 40 is bonded to substrate 30 via second adhesive layer 35. As a result, wavelength conversion member 10 is obtained.

### (Modification)

In wavelength conversion member 10, the thermal conductivity of heat sink 40 may be smaller than the thermal conductivity of substrate 30. The thermal conductivity of substrate 30 is higher than the thermal conductivity of phosphor layer 20. When the thermal conductivity of phosphor layer 20 is represented by κ1, the thermal conductivity of substrate 30 is represented by κ2, and the thermal conductivity of heat sink 40 is represented by κ3, wavelength conversion member 10 may satisfy the relationship of κ2>κ3>κ1. That is, substrate 30 having a higher thermal conductivity than phosphor layer 20 and heat sink 40 is provided between phosphor layer 20 and heat sink 40. According to such a configuration, heat of phosphor layer 20 easily diffuses inside substrate 30. The heat diffused inside substrate 30 is transmitted to heat sink 40, whereby higher heat dissipation can be ensured. When the area of the main surface of substrate 30 is larger than the area of the main surface of phosphor layer 20, the above effect can be more sufficiently obtained.

In the present modification, the thickness of substrate 30 is, for example, 100 μm or more. When the thickness of substrate 30 is adjusted appropriately while satisfying the thermal conductivity relationship of κ2>κ3>κ1, it is possible to suppress a difference in thermal expansion between phosphor layer 20 and substrate 30 and a difference in thermal expansion between substrate 30 and heat sink 40, while maintaining excellent heat dissipation performance of wavelength conversion member 10. Thus, damage of wavelength conversion member 10 due to heat can be prevented.

In a case where the thermal conductivity relationship of κ2>κ3>κ1 is established, there is no particular desirable upper limit for the thickness of substrate 30. Considering cost, weight, etc., the thickness of substrate 30 is, for example, 1000 μm or less.

The materials of phosphor layer 20, substrate 30, and heat sink 40 can be appropriately selected such that the thermal conductivity relationship of κ2>κ3>κ1 is satisfied. Examples of materials for phosphor layer 20, substrate 30, and heat sink 40 are as described above.

In one example, substrate 30 is a SiC substrate. It is known that SiC is a non-metallic material with excellent thermal conductivity. In a case where substrate 30 is made of SiC, the thermal conductivity relationship of κ2>κ3>κ1 can be easily satisfied. SiC may be a SiC single crystal or polycrystalline SiC. The thermal conductivity of a SiC single crystal is higher than that of polycrystalline SiC. From the viewpoint of excellent heat conduction from phosphor layer 20 to heat sink 40, it is preferable that substrate 30 is made of a SiC single crystal.

In the present modification, the thickness of first adhesive layer 25 can be 1/500 or more and 3/20 or less of the thickness of phosphor layer 20. The thickness of first adhesive layer 25 is sufficiently smaller than the thickness of phosphor layer 20. The thermal conductivity of first adhesive layer 25 is smaller than the thermal conductivity of phosphor layer 20, for example. When the thermal conductivity of phosphor layer 20 is represented by κ1, and the thermal conductivity of first adhesive layer 25 is represented by κ4, wavelength conversion member 10 satisfies the relationship of κ1>κ4. By providing first adhesive layer 25, it is possible to suppress rapid heat conduction from phosphor layer 20 to substrate 30 while maintaining excellent heat dissipation performance of wavelength conversion member 10. Thus, damage to wavelength conversion member 10 due to a difference in thermal expansion can be prevented.

In the present modification, the thickness of second adhesive layer 35 can be 1/1000 or more and ½ or less of the thickness of substrate 30. The thickness of second adhesive layer 35 is sufficiently smaller than the thickness of substrate 30. The thermal conductivity of second adhesive layer 35 is smaller than the thermal conductivity of substrate 30, for example. When the thermal conductivity of substrate 30 is represented by κ2, and the thermal conductivity of second adhesive layer 35 is represented by κ5, wavelength conversion member 10 satisfies the relationship of κ2>κ5. By providing second adhesive layer 35, it is possible to suppress rapid heat conduction from substrate 30 to heat sink 40 while maintaining excellent heat dissipation performance of wavelength conversion member 10. Thus, damage to wavelength conversion member 10 due to a difference in thermal expansion can be prevented.

Examples of the materials of first adhesive layer 25 and second adhesive layer 35 are as described above.

### Exemplary Embodiment of Light Source

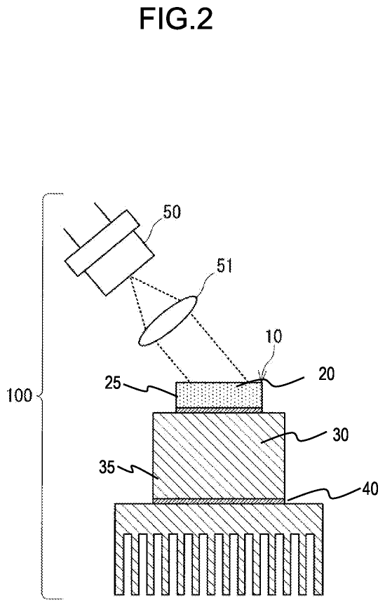

FIG. 2 shows a cross section of light source 100 using wavelength conversion member 10 according to the present disclosure. Light source 100 includes wavelength conversion member 10 and light emitting element 50. Phosphor layer 20 of wavelength conversion member 10 is located between light emitting element 50 and substrate 30 of wavelength conversion member 10. Light source 100 is a reflective light source.

Light emitting element 50 emits excitation light. Light emitting element 50 is typically a semiconductor light emitting element. The semiconductor light emitting element is, for example, a light emitting diode (LED), a superluminescent diode (SLD), or a laser diode (LD). When the LD is used as the light emitting element 50, wavelength conversion member 10 according to the present disclosure exerts a particularly high effect.

Light emitting element 50 may include a single LD, or a plurality of optically coupled LDs. Light emitting element 50 emits blue light, for example. In the present disclosure, blue light is light having a peak wavelength in the range of 420 nm to 470 nm.

Light source 100 further includes optical system 51. Optical system 51 may be located on an optical path of the excitation light emitted from light emitting element 50. Optical system 51 includes optical components such as lenses, mirrors, and optical fibers.

### Exemplary Embodiment of Projector

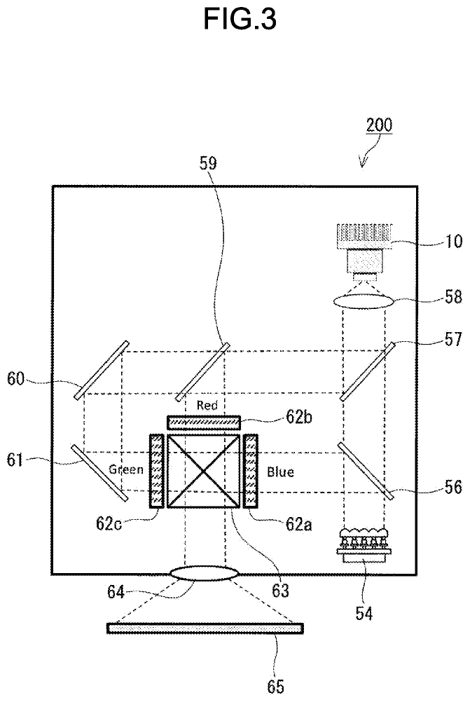

FIG. 3 schematically shows the configuration of projector 200 using wavelength conversion member 10. Projector 200 includes wavelength conversion member 10 and light emitting element 54. Wavelength conversion member 10 is disposed on an optical path of light emitted from light emitting element 54. Light emitting element 54 can be a laser diode capable of emitting blue light. Projector 200 has neither a rotary wheel substrate nor a driving device for driving the rotary wheel substrate. Wavelength conversion member 10 is fixed to, for example, a housing of projector 200. Light emitted from light emitting element 54 continues to be radiated to a fixed position of wavelength conversion member 10.

In the example shown in FIG. 3, projector 200 is a three-panel projector. However, the model of the projector to which wavelength conversion member 100 according to the present disclosure is applied is not particularly limited. Wavelength conversion member 100 according to the present disclosure can also be used, for example, in a single-panel projector.

Projector 200 further includes polarizing beam splitter 56, dichroic mirror 57, condenser lens 58, dichroic mirror 59, mirror 60, mirror 61, display element 62a, display element 62b, display element 62c, prism 63, and projection lens 64. Each of display elements 62a, 62b, and 62c may be a digital mirror device or a liquid crystal panel.

Blue light emitted from light emitting element 54 is split into p-polarized light and s-polarized light by polarizing beam splitter 56. For example, p-polarized light enters display element 62a for blue, and s-polarized light is radiated to wavelength conversion member 10 through dichroic mirror 57 and condenser lens 58. Fluorescence emitted from wavelength conversion member 10 contains red light and green light, is reflected by dichroic mirror 57, and travels toward dichroic mirror 59. Red light is reflected by dichroic mirror 59 and enters display element 62b for red. Green light passes through dichroic mirror 59, is reflected by mirrors 60 and 61, and enters display element 62c for green. The light that has passed through display elements 62a, 62b, and 62c is superposed by prism 63. As a result, an image or video to be projected on screen 65 outside projector 200 is generated. Projection lens 64 projects the image or video onto screen 65 outside projector 200.

### Exemplary Embodiment of Lighting Device

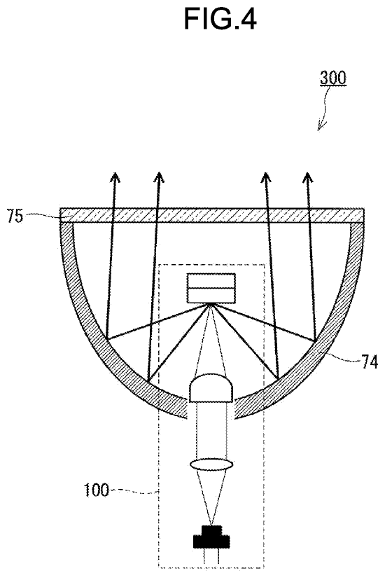

FIG. 4 schematically shows the configuration of lighting device 300 using light source 100. Lighting device 300 includes light source 100 and optical component 74. Optical component 74 is a component for guiding the light radiated from light source 100 forward, and specifically, is a reflector. Optical component 74 has, for example, a metal film made of Al, Ag, or the like or has an Al film having a protective film formed on the surface. Filter 75 may be provided in front of light source 100. Filter 75 absorbs or scatters blue light such that the coherent blue light from the light emitting element of light source 100 does not directly go out. Lighting device 300 is, for example, a vehicle headlamp.

### EXAMPLES

### (Sample 1)

A wavelength conversion member having the structure described with reference to FIGS. 1A and 1B was produced.

As a raw substrate, a silicon single crystal wafer having a silver reflective film having a thickness of 0.2 μm was prepared. The silicon single crystal wafer was cut into a square shape having a size of 5 mm×5 mm to obtain a silicon single crystal substrate having a silver reflective film and a thickness of 380 μm. The thermal conductivity of the substrate was 168 W/m·K.

Next, a first adhesive layer having a thickness of 0.4 μm made of SiO₂ was formed over the entire upper surface of the substrate by a sputtering method. The thermal conductivity of the first adhesive layer was 1.4 W/m·K.

Next, a phosphor layer was formed on the first adhesive layer. First, a ZnO thin film as a seed layer was formed on the first adhesive layer by a sputtering method. Phosphor particles of Y₃Al₅O₁₂:Ce were deposited on the ZnO thin film by electrophoresis. Crystalline ZnO was grown by a solution-growth method to form a circular phosphor layer having a thickness of 60 μm and a diameter of 3 mm. The thermal conductivity of the phosphor layer was 10 W/m·K.

Next, an opaque heat release grease was applied to the entire back surface of the substrate to form a second adhesive layer having a thickness of 5 μm. The thermal conductivity of the second adhesive layer was 8.5 W/m·K. The opaque heat release grease is an adhesive containing silicone resin and metal particles.

The substrate was bonded to the upper surface of a heat sink via the second adhesive layer. As a result, the wavelength conversion member of Sample 1 was obtained. As the heat sink, a square aluminum block having dimensions of 20 mm×20 mm×5 mm (length×width×thickness) was used. The thermal conductivity of the heat sink was 236 W/m·K.

In Sample 1, the thermal conductivity κ1 of the phosphor layer, the thermal conductivity κ2 of the substrate, and the thermal conductivity κ3 of the heat sink satisfied the relationship of κ3>κ2>κ1.

### (Sample 2)

A phosphor layer having a silicone resin matrix was directly formed on the upper surface of a heat sink to obtain a wavelength conversion member of Sample 2. The phosphor layer had a circular shape with a thickness of 60 μm and a diameter of 3 mm. The thermal conductivity of the phosphor layer was 1 W/m·K. The heat sink and phosphor particles in Sample 2 were the same as those in Sample 1.

### (Sample 3)

As a phosphor layer, a circular phosphor ceramic having a thickness of 150 μm and a diameter of 3 mm was prepared. As a phosphor, Y₃Al₅O₁₂:Ce was used. The thermal conductivity of the phosphor ceramic was 10 W/m·K.

Next, a transparent heat release grease was applied to the entire back surface of the phosphor ceramic to form a second adhesive layer having a thickness of 15 μm. The thermal conductivity of the second adhesive layer was 3 W/m·K. The transparent heat release grease is an adhesive containing silicone resin and alumina particles.

The phosphor ceramic was bonded to the upper surface of the heat sink via the second adhesive layer. As a result, the wavelength conversion member of Sample 3 was obtained. The heat sink in Sample 3 was the same as the heat sink in Sample 1.

### [Measurement of Fluorescence Intensity]

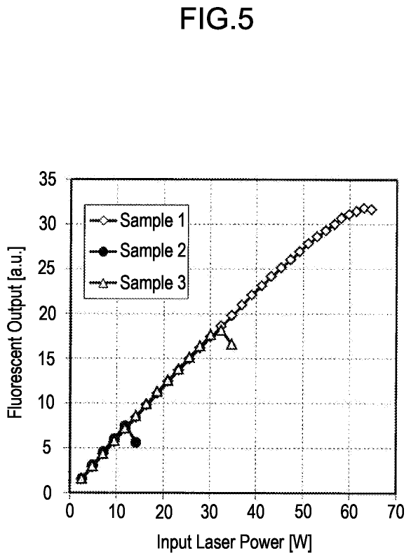

The upper surfaces of the phosphor layers of the wavelength conversion members of Sample 1, Sample 2, and Sample 3 were irradiated with a laser beam having a diameter of φ2 mm, and the intensity of the emitted fluorescence was measured. The intensity of the laser beam was gradually increased. The laser beam was a blue laser with a wavelength of 455 nm. The results are shown in FIG. 5.

The fluorescence intensity of the wavelength conversion member of Sample 1 continued to increase until a laser beam having an intensity of more than 60 W was applied. The maximum value of the fluorescent output of the wavelength conversion member of Sample 1 was 31.8 W.

The fluorescence intensity of the wavelength conversion member of Sample 2 began to decrease when a laser beam having an intensity of 14 W was applied. The maximum value of the fluorescent output of the wavelength conversion member of Sample 2 was 7.5 W. The fluorescence intensity of the wavelength conversion member of Sample 3 began to decrease when a laser beam having an intensity of 35 W was applied. The maximum value of the fluorescent output of the wavelength conversion member of Sample 3 was 18.1 W.

It is considered that the cause of the decrease in fluorescence intensity is the temperature quenching of the phosphor. The results shown in FIG. 5 indicate that the heat dissipation of the wavelength conversion member of Sample 1 is far superior to that of the wavelength conversion members of Sample 2 and Sample 3.

[Simulation of Surface Temperature of Phosphor Layer]

The surface temperatures (temperatures of the upper surfaces) of the phosphor layers when the upper surfaces of the phosphor layers of the wavelength conversion members of Sample 1, Sample 2, and Sample 3 were irradiated with a laser beam having a diameter of 2 mm and an output of 60 W were examined by computer simulation. It was assumed that the lateral surfaces and the bottom surfaces of the heat sinks were maintained at room temperature (25° C.), and the other surfaces were cooled by radiant heat dissipation. The intensity distribution of the laser beam was assumed to be a normal distribution. The laser beam was a blue laser with a wavelength of 455 nm. The results are shown in Table 1.

TABLE 1

| | Surface temperature of |
|---|---|
| | phosphor layer during |
| | irradiation of laser beam |
| | of 60 W |
| Sample 1 | 178° C. |
| Sample 2 | 1223° C. |
| Sample 3 | 256° C. |

The surface temperature of the phosphor layer of the wavelength conversion member of Sample 1 was sufficiently lower than the surface temperatures of the phosphor layers of the wavelength conversion members of Sample 2 and Sample 3. It is known that the temperature quenching of YAG-based phosphors becomes apparent at about 250° C. The surface temperature of the phosphor layer of the wavelength conversion member of Sample 1 during irradiation of laser beam with 60 W is as low as 178° C., and it is considered that there is almost no effect of temperature quenching even if 60 W laser beam is used. It is considered that, since the surface temperatures of the phosphor layers of the wavelength conversion members of Sample 2 and Sample 3 during irradiation of 60 W laser beam are above 250° C., the temperatures inside the phosphor layers are above 250° C., and the effect of temperature quenching when 60 W laser beam is used is significant.

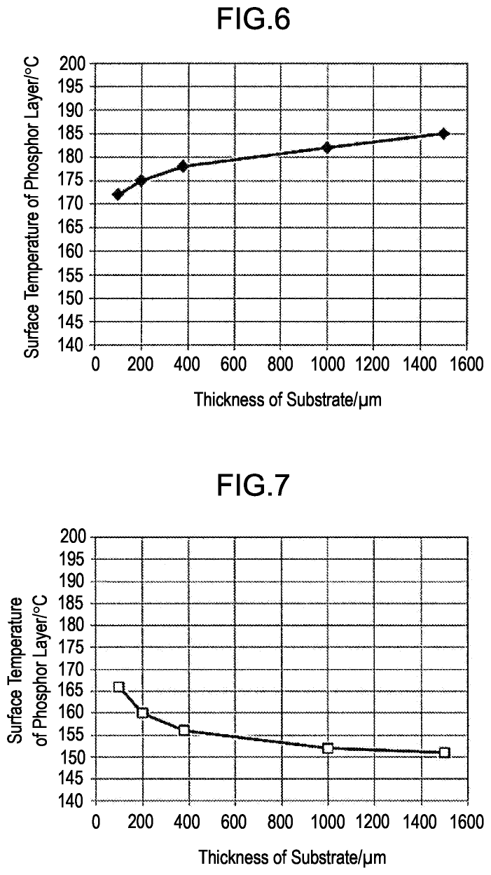

Next, the surface temperatures of phosphor layers of wavelength conversion members of Sample 4 to Sample 7 obtained by changing the thickness of the substrate of the wavelength conversion member of Sample 1 were examined by computer simulation. The substrate thicknesses of the wavelength conversion members of Sample 4, Sample 5, Sample 6, and Sample 7 were 100 μm, 200 μm, 1000 μm, and 1500 μm, respectively. The results are shown in Table 2 and FIG. 6.

TABLE 2

| | | Surface temperature of |
|---|---|---|
| | | phosphor layer during |
| | Thickness of | irradiation of laser beam |
| | substrate | of 60 W |
| Sample 4 | 100 μm | 172° C. |
| Sample 5 | 200 μm | 175° C. |
| Sample 1 | 380 μm | 178° C. |
| Sample 6 | 1000 μm | 182° C. |
| Sample 7 | 1500 μm | 185° C. |

The surface temperature of each of the phosphor layers was 185° C. or lower. All wavelength conversion members of Sample 1, Sample 4, Sample 5, Sample 6, and Sample 7 can withstand the application of 60 W laser beam.

As shown in Table 2, the thinner the substrate, the lower the surface temperature of the phosphor layer. From the viewpoint of cost, the thinner the substrate, the more desirable it is. However, the thinner the substrate, the more difficult it is to handle the substrate, and the yield at the time of manufacturing the wavelength conversion member may decrease. Therefore, from the viewpoint of cost and productivity, it is desirable that the thickness of the substrate is 100 μm or more.

The surface temperature of the phosphor layer when the substrate had a thickness of 100 μm was 172° C. The substrate thickness when the surface temperature of the phosphor layer reaches 172° C.+10° C. is used as one standard level for the desired upper limit of the substrate thickness, for example. From this point of view, it is appropriate to select 1000 μm as the desired upper limit of the substrate thickness.

### (Sample 8 to Sample 15)

Wavelength conversion members of Sample 8 to Sample 15 were prepared in the same manner as Sample 1, except that the thicknesses of the first adhesive layer and the second adhesive layer were different. The thicknesses of the first adhesive layer and the second adhesive layer of the wavelength conversion members of Samples 8 to 15 are as shown in Table 3.

### [Heat Shock Test]

Heat shock was applied to the wavelength conversion members of Samples 1 and 8 to 15, and whether or not peeling occurred was checked. The heat shock was applied to the wavelength conversion members in the following procedure. The wavelength conversion members of Samples 1 and 8 to 15 were allowed to stand in an environment of −40° C. for 30 minutes. Thereafter, they were moved to an environment of 200° C. in 30 seconds, and allowed to stand for 30 minutes. Then, they were moved to an environment of −40° C. in 30 seconds. This operation was set as one cycle, and was repeated 500 cycles.

### [Simulation of Surface Temperature of Phosphor Layer]

The surface temperatures of the phosphor layers of the wavelength conversion members of Samples 8 to 15 were examined by the computer simulation described above.

TABLE 3

| | Thickness of | Thickness of | Surface temperature of | | |
|---|---|---|---|---|---|
| | first adhesive | second | phosphor layer during | | |
| | layer | adhesive layer | irradiation of laser beam of | Temperature | Peeling |
| | (μm) | (μm) | 60 W | assessment | occurred? |
| Sample 1 | 0.4 | 5 | 178° C. | ∘ | No |
| Sample 8 | 0.02 | 5 | 174° C. | ∘ | Yes |
| Sample 9 | 0.06 | 5 | 174° C. | ∘ | No |
| Sample 10 | 6 | 5 | 236° C. | ∘ | No |
| Sample 11 | 10 | 5 | 278° C. | Δ | No |
| Sample 12 | 0.4 | 0.1 | 175° C. | ∘ | Yes |
| Sample 13 | 0.4 | 0.38 | 175° C. | ∘ | No |
| Sample 14 | 0.4 | 38 | 192° C. | ∘ | No |
| Sample 15 | 0.4 | 380 | 257° C. | Δ | No |

The criteria for the temperature assessment items shown in Table 3 are as follows.

The surface temperature of the phosphor layer is less than 250° C.: ∘

The surface temperature of the phosphor layer is 250° C. or higher: Δ

In the heat shock test, peeling was observed in the wavelength conversion members of Sample 8 and Sample 12. Whether or not peeling occurred was checked visually and with an optical microscope. In the wavelength conversion member of Sample 8, peeling was observed in the first adhesive layer. The residue of the first adhesive layer remained on both the phosphor layer and the substrate. Therefore, it was unable to determine whether the peeling occurred between the first adhesive layer and the phosphor layer or between the first adhesive layer and the substrate. In the wavelength conversion member of Sample 12, peeling was observed in the second adhesive layer. The residue of the second adhesive layer remained on both the substrate and the heat sink. Therefore, it was unable to determine whether the peeling occurred between the second adhesive layer and the substrate or between the second adhesive layer and the heat sink.

As can be understood from the simulation results of the surface temperatures of the phosphor layers of Samples 11 and 15, if the first adhesive layer and the second adhesive layer are too thick, the heat dissipation deteriorates, and the surface temperature of the phosphor layer is likely to rise. As can be seen from the results of the heat shock test of Samples 8 and 12, if the first adhesive layer and the second adhesive layer are too thin, peeling is likely to occur when heating and cooling are repeated. That is, there is a trade-off relationship between heat dissipation and peel resistance, and it is not easy to improve both of them. However, according to the technique of the present disclosure, it is possible to achieve both heat dissipation and peel resistance.

From the results shown in Table 3, a desirable range of the thickness of the first adhesive layer is 1/1000 or more and 1/10 or less of the thickness of the phosphor layer (60 μm) from Samples 9 and 10. A desirable range of the thickness of the second adhesive layer is 1/1000 or more and 1/10 or less of the thickness of the substrate (380 μm) from Samples 13 and 14. With this configuration, it can be said that both heat dissipation and peel resistance can be achieved.

### (Sample 16)

A wavelength conversion member of Sample 16 was prepared in the same manner as Sample 1 except that a SiC single crystal substrate having a thickness of 380 μm was used instead of the silicon single crystal substrate. In Sample 16, the thermal conductivity of the substrate was 400 W/m·K.

In Sample 16, the thermal conductivity κ1 of the phosphor layer, the thermal conductivity κ2 of the substrate, and the thermal conductivity κ3 of the heat sink satisfied the relationship of κ2>κ3>κ1.

### [Simulation of Surface Temperature of Phosphor Layer]

The surface temperature of the phosphor layer when the upper surface of the phosphor layer of the wavelength conversion member of Sample 16 was irradiated with a laser beam having a diameter of 2 mm and an output of 60 W was examined by computer simulation. It was assumed that the lateral surface and the bottom surface of the heat sink were maintained at room temperature (25° C.) and the other surfaces were cooled by radiant heat dissipation. The intensity distribution of the laser beam was assumed to be a normal distribution. The laser beam was a blue laser with a wavelength of 455 nm. The results are shown in Table 4.

In addition, the surface temperatures of phosphor layers of wavelength conversion members of Sample 17 to Sample 20 obtained by changing the thickness of the substrate of the wavelength conversion member of Sample 16 were also examined by computer simulation. The substrate thicknesses of the wavelength conversion members of Sample 17, Sample 18, Sample 19, and Sample 20 were 100 μm, 200 μm, 1000 μm, and 1500 μm, respectively. The results are shown in Table 4 and FIG. 7.

TABLE 4

| | | Surface temperature of |
|---|---|---|
| | | phosphor layer during |
| | Thickness of | irradiation of laser beam |
| | substrate | of 60 W |
| Sample 17 | 100 μm | 166° C. |
| Sample 18 | 200 μm | 160° C. |
| Sample 16 | 380 μm | 156° C. |
| Sample 19 | 1000 μm | 152° C. |
| Sample 20 | 1500 μm | 151° C. |

The surface temperature of each of the phosphor layers was 166° C. or lower. All wavelength conversion members of Samples 16 to 20 can withstand the application of 60 W laser beam.

As shown in Table 4, the thicker the substrate, the lower the surface temperature of the phosphor layer. That is, when the substrate had a thickness of 100 μm or more, the surface temperature of the phosphor layer could be maintained at a sufficiently low temperature. From the viewpoint of cost, the thinner the substrate, the more desirable it is. The thinner the substrate, the more difficult it is to handle the substrate, and the yield at the time of manufacturing the wavelength conversion member may decrease. With all of these points considered, it is desirable that the thickness of the substrate is 100 μm or more.

### (Sample 21 to Sample 28)

Wavelength conversion members of Sample 21 to Sample 28 were prepared in the same manner as Sample 16, except that the thicknesses of the first adhesive layer and the second adhesive layer were different. The thicknesses of the first adhesive layer and the second adhesive layer of the wavelength conversion members of Samples 21 to 28 are as shown in Table 5.

### [Heat Shock Test]

Heat shock was applied to the wavelength conversion members of Samples 16 and 21 to 28 according to the procedure described above, and whether or not peeling occurred was checked. The results are shown in Table 5.

### [Simulation of Surface Temperature of Phosphor Layer]

The surface temperatures of the phosphor layers of the wavelength conversion members of Samples 21 to 28 were examined by the computer simulation described above. The criteria for the temperature assessment items shown in Table 5 are the same as the criteria in Table 3.

TABLE 5

| | Thickness of | Thickness of | Surface temperature of | | |
|---|---|---|---|---|---|
| | first adhesive | second | phosphor layer during | | |
| | layer | adhesive layer | irradiation of laser beam of | Temperature | Peeling |
| | (μm) | (μm) | 60 W | assessment | occurred? |
| Sample 16 | 0.4 | 5 | 156° C. | ∘ | No |
| Sample 21 | 0.06 | 5 | 152° C. | ∘ | Yes |
| Sample 22 | 0.12 | 5 | 154° C. | ∘ | No |
| Sample 23 | 9 | 5 | 246° C. | ∘ | No |
| Sample 24 | 12 | 5 | 277° C. | Δ | No |
| Sample 25 | 0.4 | 0.1 | 154° C. | ∘ | Yes |
| Sample 26 | 0.4 | 0.38 | 155° C. | ∘ | No |
| Sample 27 | 0.4 | 190 | 189° C. | ∘ | No |
| Sample 28 | 0.4 | 380 | 216° C. | ∘ | Yes |

In the heat shock test, peeling was observed in the wavelength conversion members of Sample 21, Sample 25, and Sample 28. In the wavelength conversion member of Sample 21, peeling was observed in the first adhesive layer. The residue of the first adhesive layer remained on both the phosphor layer and the substrate. Therefore, it was unable to determine whether the peeling occurred between the first adhesive layer and the phosphor layer or between the first adhesive layer and the substrate. In the wavelength conversion member of Sample 25, peeling was observed in the second adhesive layer. In the wavelength conversion member of Sample 28, peeling was observed in the second adhesive layer. In both Sample 25 and Sample 28, the residue of the second adhesive layer remained on both the substrate and the heat sink. Therefore, it was unable to determine whether the peeling occurred between the second adhesive layer and the substrate or between the second adhesive layer and the heat sink.

The wavelength conversion member of Sample 28 had a second adhesive layer of sufficient thickness. However, it is considered that, due to the second adhesive layer being thick, a difference in temperature between the upper surface and the lower surface of the second adhesive layer is increased, which causes peeling.

As can be understood from the simulation result of the surface temperature of the phosphor layer of Sample 24, if the adhesive layer is too thick, the heat dissipation deteriorates, and the surface temperature of the phosphor layer is likely to rise. As can be seen from the results of the heat shock test of Samples 21 and 25, if the first adhesive layer and the second adhesive layer are too thin, peeling is likely to occur when heating and cooling are repeated. That is, there is a trade-off relationship between heat dissipation and peel resistance, and it is not easy to improve both of them. However, according to the technique of the present disclosure, it is possible to achieve both heat dissipation and peel resistance.

From the results shown in Table 5, a desirable range of the thickness of the first adhesive layer is 1/500 or more and 3/20 or less of the thickness of the phosphor layer (60 μm) from Samples 22 and 23. A desirable range of the thickness of the second adhesive layer is 1/1000 or more and ½ or less of the thickness of the substrate (380 μm) from Samples 26 and 27. With this configuration, it can be said that both heat dissipation and peel resistance can be achieved.

### INDUSTRIAL APPLICABILITY

The wavelength conversion member according to the present disclosure can be used in general lighting devices such as ceiling lights. Further, the wavelength conversion member according to the present disclosure can be used for special lighting devices such as spotlights, stadium lighting, and studio lighting. Furthermore, the wavelength conversion member according to the present disclosure can be used for vehicle lighting devices such as headlamps. In addition, the wavelength conversion member according to the present disclosure can be used in projection devices such as projectors or head-up displays. In addition, the wavelength conversion member according to the present disclosure can be used for: medical or industrial endoscope lights; and imaging devices such as digital cameras, mobile phones, and smartphones. Further, the wavelength conversion member according to the present disclosure can be used for information devices such as monitors for personal computers (PCs), notebook personal computers, televisions, personal digital assistants (PDX), smartphones, tablet PCs, and mobile phones.

### REFERENCE MARKS IN THE DRAWINGS

10: wavelength conversion member

20: phosphor layer

22: matrix

23: phosphor particle

25: first adhesive layer

30: substrate

35: second adhesive layer

40: heat sink

100: light source

200: projector

300: lighting device

1. A wavelength conversion member comprising:
a phosphor layer containing a phosphor;
a substrate that supports the phosphor layer; and
a heat sink bonded to the substrate, wherein
the substrate has a thermal conductivity greater than a thermal conductivity of the phosphor layer, and
the thermal conductivity of the substrate is different from a thermal conductivity of the heat sink.

2. The wavelength conversion member according to claim 1, wherein the thermal conductivity of the heat sink is greater than the thermal conductivity of the substrate.

3. The wavelength conversion member according to claim 2, wherein the substrate has a thickness ranging from 100 ∞m to 1000 μm inclusive.

4. The wavelength conversion member according to claim 2, further comprising a first adhesive layer provided between the phosphor layer and the substrate, wherein
the first adhesive layer has a thickness that is 1/1000 or more and 1/10 or less of a thickness of the phosphor layer, and
the first adhesive layer has a thermal conductivity smaller than the thermal conductivity of the phosphor layer.

5. The wavelength conversion member according to claim 2, further comprising a second adhesive layer provided between the substrate and the heat sink, wherein
the second adhesive layer has a thickness that is 1/1000 or more and 1/10 or less of a thickness of the substrate, and
the second adhesive layer has a thermal conductivity smaller than the thermal conductivity of the substrate.

6. The wavelength conversion member according to claim 2, wherein the substrate includes silicon.

7. The wavelength conversion member according to claim 1, wherein the thermal conductivity of the heat sink is smaller than the thermal conductivity of the substrate.

8. The wavelength conversion member according to claim 7, wherein the substrate has a thickness equal to or greater than 100 μm.

9. The wavelength conversion member according to claim 7, further comprising a first adhesive layer provided between the phosphor layer and the substrate, wherein
the first adhesive layer has a thickness that is 1/500 or more and 3/20 or less of a thickness of the phosphor layer, and
the first adhesive layer has a thermal conductivity smaller than the thermal conductivity of the phosphor layer.

10. The wavelength conversion member according to claim 7, further comprising a second adhesive layer provided between the substrate and the heat sink, wherein
the second adhesive layer has a thickness that is 1/1000 or more and ½ or less of a thickness of the substrate, and
the second adhesive layer has a thermal conductivity smaller than the thermal conductivity of the substrate.

11. The wavelength conversion member according to claim 7, wherein the substrate includes silicon carbide (SiC).

12. The wavelength conversion member according to claim 1, wherein the phosphor layer includes an inorganic material.

13. The wavelength conversion member according to claim 1, wherein the phosphor layer has a plurality of phosphor particles and a zinc oxide matrix, the plurality of phosphor particles being embedded in the zinc oxide matrix.

14. A projector comprising:
a light emitting element; and
the wavelength conversion member according to claim 1 that is located on an optical path of light emitted from the light emitting element.
